(19) United States
(12) Patent Application Publication
(10) Pub. No.: US 2025/0280992 A1
(43) Pub. Date: Sep. 11, 2025

(54) COFFEE MACHINE AND WATER HEATING SYSTEM THEREFOR

(71) Applicant: Tsann Kuen (Zhangzhou) Enterprise Co., Ltd., Zhangzhou City (CN)

(72) Inventors: Zhenwei GUO, Zhangzhou City (CN); Pengwei HU, Zhangzhou City (CN); Yafei HAN, Zhangzhou City (CN)

(21) Appl. No.: 19/069,429

(22) Filed: Mar. 4, 2025

(30) Foreign Application Priority Data
Mar. 5, 2024 (CN) 202420422714.0

(51) Int. Cl. A47J 31/54; A47J 31/46; A47J 31/52; A47J 31/56; F24H 1/10; F24H 15/219

(52) U.S. Cl. CPC A47J 31/545; A47J 31/461; A47J 31/468; A47J 31/5253; A47J 31/56; F24H 1/105; F24H 15/219; A47J 2202/00

(57) ABSTRACT

A coffee machine and a water heating system for a coffee machine are provided. The water heating system for a coffee machine includes a water pump, an air pump, a three-way valve and a heating tube. The three-way valve has a first port, a second port and a third port that are communicated with each other. A water outlet end of the water pump is connected to the first port of the three-way valve. An air outlet end of the air pump is connected to the second port of the three-way valve. The third port of the three-way valve is connected to the heating tube. The air pump is arranged at a larger height than the water pump and the three-way valve, and a caliber of the second port of the three-way valve is smaller than that of the first port and the third port.

### CROSS-REFERENCE TO RELATED APPLICATIONS

This application claims priority to Chinese Patent Application 202420422714.0, filed on Mar. 5, 2024, which is incorporated herein by reference.

### TECHNICAL FIELD

The invention relates to the field of coffee machines, and in particular to a coffee machine and a water heating system for a coffee machine.

### BACKGROUND

There is an increasing demand for capsule coffee machines in the market today. For the existing capsule coffee machine in the market, water is pumped by the water pump from the water tank into the heating tube along the three-way valve and heated by the heating tube to a temperature suitable for brewing coffee, and finally, the hot water is injected into an extraction container via the water outlet of the heating tube for coffee extraction. After the extraction is completed, the air pump works, i.e., the air is blown in from the second port of the three-way valve to discharge the remaining water and coffee concentrate in the water path system, thereby obtaining a cup of delicious coffee.

However, in the design of the heating system, during the process of pumping water into the heating tube by the water pump, the air between the three-way valve and the air pump easily enters the water tube to form bubbles. In this case, after the water mixed with air flows into the heating tube, the water will be heated unevenly, which leads to unstable temperature change and intermittent water output, thereby affecting the flavor of brewed coffee and the user experience.

### SUMMARY

In view of this, in order to solve the above problem, the invention provides a coffee machine and a water heating system therefor.

In order to achieve the above objective, the invention provides the following technical solution:

A water heating system for a coffee machine includes a water pump, an air pump, a three-way valve and a heating tube. The three-way valve has a first port, a second port and a third port that are communicated with each other. A water outlet end of the water pump is connected to the first port of the three-way valve. An air outlet end of the air pump is connected to the second port of the three-way valve. The third port of the three-way valve is connected to the heating tube. The air pump is arranged at a larger height than the water pump and the three-way valve, and a caliber of the second port of the three-way valve is smaller than that of the first port and the third port.

Further, the first port and the third port have the same caliber. The caliber of the second port of the three-way valve is more than 35% of the caliber of the first port and the third port, and preferably, the caliber of the second port of the three-way valve is 35%-40% of the caliber of the first port and the third port.

Further, the water heating system for a coffee machine further includes an inner support. The water pump, the air pump, the three-way valve and the heating tube are all assembled on the inner support.

Further, the air pump is at least 50 mm higher than the water pump and the three-way valve.

Further, the water pump is assembled at a bottom of the inner support, the three-way valve and the heating tube are assembled at a side of the inner support, and the air pump is assembled at a top of the inner support.

Further, the bottom of the inner support is provided with a mounting recess, the water pump is assembled in the mounting recess at the bottom, and the mounting recess is communicated with the side where the three-way valve is mounted.

Further, the heating tube has a U-shaped structure.

Further, the heating tube is an electric heating tube.

A coffee machine includes at least the water heating system for a coffee machine described above.

Further, a water pump, an air pump and a heating tube are all connected to a main controller of the coffee machine. The coffee machine further includes a water temperature sensor, and the water temperature sensor is arranged at a water outlet of the heating tube to sense a temperature of hot water flowing out of the heating tube. An output of the water temperature sensor is connected to the main controller of the coffee machine.

The technical solution provided by the invention has the following beneficial effects:

By arranging the air pump at a larger height than the water pump and the three-way valve and making the caliber of the second port of the three-way valve smaller than the caliber of the first port and the third port, when the water pumped by the water pump enters the heating tube, the air between the three-way valve and the air pump can be effectively prevented from entering the water path, which avoids unstable water output temperature and unstable water output speed, thereby improving the stability of the whole system and ensuring the water output speed and stability.

### BRIEF DESCRIPTION OF DRAWINGS

FIG. 1 shows a schematic three-dimensional structural view of a water heating system for a coffee machine in an embodiment;

FIG. 2 shows a side view of the water heating system for a coffee machine in an embodiment;

FIG. 3 shows a bottom view of the water heating system for a coffee machine in an embodiment;

FIG. 4 shows a schematic structural view of a three-way valve in an embodiment; and

FIG. 5 shows a block diagram of a coffee machine in an embodiment, where the solid lines show structural connection relationships and the dashed lines show electrical connection relationships.

### DESCRIPTION OF EMBODIMENTS

To further illustrate the embodiments, the accompanying drawings are provided in the invention. These accompanying drawings are a part of the contents disclosed in the invention that are mainly used to illustrate the embodiments, and can be used in conjunction with the related descriptions in the specification to explain the operation principle of the embodiments. With reference to these contents, those of ordinary skill in the art should be able to understand other possible implementations and advantages of the invention. Components in the drawings are not drawn to scale, and like component symbols are usually used to represent like components.

In the description of the invention, the orientation or positional relationship indicated by the term “upper”, “lower”, “left”, “right”, “front”, “rear” or the like is based on the orientation or positional relationship shown in the accompanying drawings. This is only for the convenience of describing the invention and simplifying the description, and does not indicate or imply that the device or element must have a specific orientation, or be constructed and operated in a specific orientation, and therefore cannot be understood as a limitation of the invention.

The invention will be further described in conjunction with the accompanying drawings and specific embodiments.

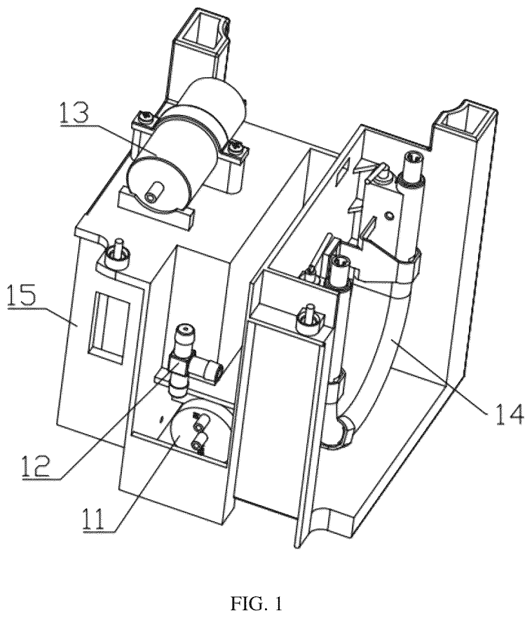

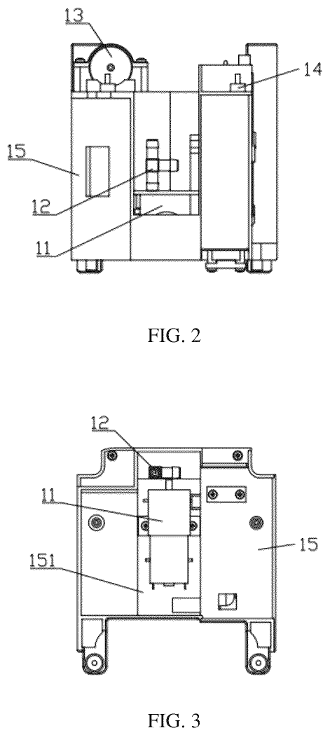

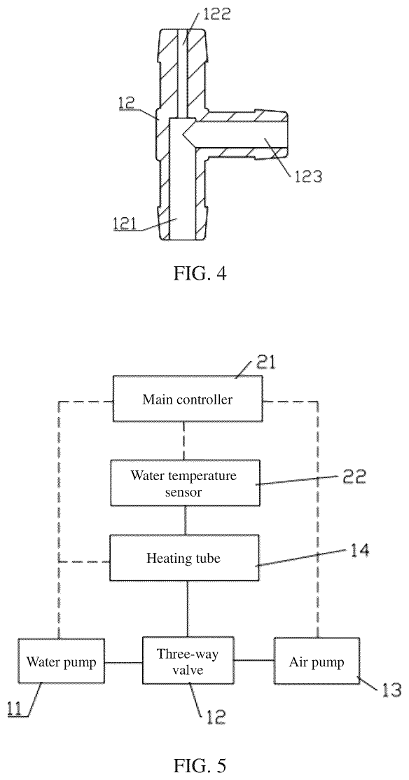

Referring to FIG. 1 to FIG. 4, a water heating system for a coffee machine provided by this embodiment includes a water pump 11, an air pump 13, a three-way valve 12 and a heating tube 14. The three-way valve 12 has a first port 121, a second port 122 and a third port 123 that are communicated with each other. A water outlet end of the water pump 11 is connected to the first port 121 of the three-way valve 12. An air outlet end of the air pump 13 is connected to the second port 122 of the three-way valve 12. The third port 123 of the three-way valve 12 is connected to the heating tube 14. Specifically, the water pump 11, the air pump 13, the three-way valve 12 and the heating tube 14 may be connected through tubes. For example, the water pump 11 is connected to the first port 121 of the three-way valve 12 through a water tube, the third port 123 of the three-way valve 12 is connected to the heating tube 14 through a water tube, and the air outlet end of the air pump 13 is connected to the second port 122 of the three-way valve 12 through an air tube. The air pump 13 is arranged at a larger height than the water pump 11 and the three-way valve 12, and a caliber of the second port 122 of the three-way valve 12 is smaller than that of the first port 121 and the third port 123.

This embodiment further provides a coffee machine, including at least the water heating system for a coffee machine described above.

The working principle of the coffee machine is as follows: Water is pumped by the water pump 11 from a water tank into the heating tube 14 along the three-way valve 12 and heated by the heating tube 14 to a temperature suitable for brewing coffee, and finally, the hot water is injected into an extraction container via the water outlet of the heating tube 14 for coffee extraction. After the extraction is completed, the air pump 13 works, i.e., the air is blown in from the second port 122 of the three-way valve 12 to discharge the remaining water and coffee concentrate in a water path system, thereby obtaining a cup of delicious coffee.

By arranging the air pump 13 at a larger height than the water pump 11 and the three-way valve 12 and making the caliber of the second port 122 of the three-way valve 12 smaller than the caliber of the first port 121 and the third port 123, when the water pumped by the water pump 11 enters the heating tube 14, the air between the three-way valve 12 and the air pump 13 can be effectively prevented from entering the water path, which avoids unstable water output temperature and unstable water output speed, thereby improving the stability of the whole system and ensuring the water output speed and stability.

Specifically, referring to FIG. 5, the water pump 11, the air pump 13 and the heating tube 14 are all connected to a main controller 21 of the coffee machine. That is, the main controller 21 of the coffee machine is configured to control the water pump 11, the air pump 13 and the heating tube 14 to work to realize coordinated operation of the components. The connection relationships and working principle mentioned above are all the prior art, and reference can be made to the existing capsule coffee machine in the market. Details will not be repeated here.

Further preferably, the coffee machine further includes a water temperature sensor 22, and the water temperature sensor 22 is arranged at a water outlet of the heating tube 14 to sense a temperature of hot water flowing out of the heating tube 14. An output of the water temperature sensor 22 is connected to the main controller 21 of the coffee machine to transmit sensed information to the main controller 21, and the main controller 21 controls a pumping speed of the water pump 11 based on the sensed water temperature information, so that the water is heated to a temperature suitable for brewing coffee, which provides more accurate water temperature control.

Preferably, the first port 121 and the third port 123 have the same caliber, which is 4 mm. The caliber of the second port 122 of the three-way valve 12 is more than 35% of the caliber of the first port 121 and the third port 123, and preferably, the caliber of the second port 122 of the three-way valve 12 is 35%-40% of the caliber of the first port 121 and the third port 123. For example, in this embodiment, the caliber of the second port 122 of the three-way valve 12 is 1.5 mm. This not only ensures the output of the air pump 13, but also prevents air from entering the water path during the pumping process of the water pump 11.

In order to make the water heating system form a whole, in this embodiment, the water heating system further includes an inner support 15, and the water pump 11, the air pump 13, the three-way valve 12 and the heating tube 14 are all assembled on the inner support 15.

The water pump 11 is assembled at a bottom of the inner support 15, the three-way valve 12 and the heating tube 14 are assembled at a side of the inner support 15, and the air pump 13 is assembled at a top of the inner support 15. The water pump 11 is located at the bottom, and the three-way valve 12 is located between the air pump 13 and the water pump 11. Preferably, the air pump 13 is at least 50 mm higher than the water pump 11 and the three-way valve 12, i.e., a vertical height between the air pump 13 and the three-way valve 12 located at the side is at least 50 mm. By making the air pump 13 have a sufficient height, the air can be prevented from entering the water path more effectively.

The bottom of the inner support 15 is provided with a mounting recess 151, the water pump 11 is assembled in the mounting recess 151 at the bottom, and the mounting recess 151 is communicated with the side where the three-way valve 12 is mounted. In this way, the water pump 11 does not affect the mounting at the bottom of the inner support 15, thereby effectively reducing the size. By making the mounting recess 151 communicated with the side where the three-way valve 12 is mounted, the water tube connecting the three-way valve 12 and the water pump 11 can pass through the communicated channel, which effectively reduces the tube length and makes the structure simpler.

The heating tube 14 is an electric heating tube, which heats water by being energized. The heating tube 14 has a U-shaped structure, which can effectively reduce the linear dimension on the premise of ensuring the heating length and also facilitate mounting.

By using the inner support 15, the water heating system can form a whole, which is convenient for modular assembly. Certainly, in other embodiments, the inner support 15 may also not be used.

Although the invention has been specifically shown and described in connection with the preferred embodiments, it should be understood by those skilled in the art that various changes in form and details can be made without departing from the spirit and scope of the invention as defined by the appended claims, and shall all fall within the protection scope of the invention.

1. A water heating system for a coffee machine, comprising a water pump, an air pump, a three-way valve and a heating tube, wherein the three-way valve has a first port, a second port and a third port that are in communication with each other, a water outlet end of the water pump is connected to the first port of the three-way valve, an air outlet end of the air pump is connected to the second port of the three-way valve, the third port of the three-way valve is connected to the heating tube, the air pump is arranged at a height higher than the water pump and the three-way valve, and a caliber of the second port of the three-way valve is smaller than calibers of the first port and the third port.

2. The water heating system for a coffee machine according to claim 1, wherein calibers of the first port of the three-way valve and the third port of the three-way valve are the same, and the caliber of the second port of the three-way valve is more than 35% of the calibers of the first port and the third port.

3. The water heating system for a coffee machine according to claim 1, further comprising an inner support, wherein the water pump, the air pump, the three-way valve and the heating tube are all assembled on the inner support.

4. The water heating system for a coffee machine according to claim 3, wherein the air pump is assembled at the inner support and is at least 50 mm higher than the water pump and the three-way valve.

5. The water heating system for a coffee machine according to claim 4, wherein the water pump is assembled at a bottom of the inner support, the three-way valve and the heating tube are assembled at a side of the inner support, and the air pump is assembled at a top of the inner support.

6. The water heating system for a coffee machine according to claim 5, wherein the bottom of the inner support is provided with a mounting recess, the water pump is assembled in the mounting recess at the bottom of the inner support, and the mounting recess is communicated with the side of the inner support where the three-way valve is mounted.

7. The water heating system for a coffee machine according to claim 1, wherein the heating tube has a U-shaped structure.

8. The water heating system for a coffee machine according to claim 1, wherein the heating tube is an electric heating tube.

9. The water heating system for a coffee machine according to claim 7, wherein the heating tube is an electric heating tube.

10. A coffee machine, comprising the water heating system for a coffee machine according to claim 1.

11. The coffee machine according to claim 10, wherein the water pump, the air pump and the heating tube are all connected to a main controller of the coffee machine, the coffee machine further comprises a water temperature sensor, the water temperature sensor is arranged at a water outlet of the heating tube to sense a temperature of water flowing out of the heating tube, and an output of the water temperature sensor is connected to the main controller of the coffee machine.

12. The coffee machine according to claim 10, wherein calibers of the first port of the three-way valve and the third port of the three-way valve are the same, and the caliber of the second port of the three-way valve is more than 35% of the calibers of the first port and the third port.

13. The coffee machine according to claim 10, further comprising an inner support, wherein the water pump, the air pump, the three-way valve and the heating tube are all assembled on the inner support.

14. The coffee machine according to claim 13, wherein the air pump is assembled at the inner support and is at least 50 mm higher than the water pump and the three-way valve.

15. The coffee machine according to claim 14, wherein the water pump is assembled at a bottom of the inner support, the three-way valve and the heating tube are assembled at a side of the inner support, and the air pump is assembled at a top of the inner support.

16. The coffee machine according to claim 15, wherein the bottom of the inner support is provided with a mounting recess, the water pump is assembled in the mounting recess at the bottom of the inner support, and the mounting recess is communicated with the side of the inner support where the three-way valve is mounted.

17. The coffee machine according to claim 10, wherein the heating tube has a U-shaped structure.

18. The coffee machine according to claim 10, wherein the heating tube is an electric heating tube.

19. The coffee machine according to claim 17, wherein the heating tube is an electric heating tube.
